(19) United States
(12) Patent Application Publication
(10) Pub. No.: US 2026/0280599 A1
(43) Pub. Date: Sep. 17, 2026

(54) Network apparatus having merged packet processing mechanism

(71) Applicant: REALTEK SEMICONDUCTOR CORPORATION, HSINCHU (TW)

(72) Inventors: TSUNG-YIN SU, HSINCHU (TW); SHIH-CHIEH CHEN, HSINCHU (TW)

(21) Appl. No.: 19/553,759

(22) Filed: Mar. 2, 2026

(30) Foreign Application Priority Data
Mar. 17, 2025 (TW) 114109949

(51) Int. Cl. H04B 1/40; H04L 69/22

(52) U.S. Cl. CPC H04B 1/40; H04L 69/22

(57) ABSTRACT

A network apparatus having a merged packet processing mechanism is provided. A packet transceiver circuit receives first network packets from a first network. A packet transferring circuit independent from the packet transceiver circuit includes a determining circuit, a processing circuit, queuing circuits and a merging circuit. The determining circuit determines and selects under-transferring packets having a transferring requirement corresponding to a second network from the first network packets. The processing circuit performs packet-processing on the under-transferring packets according to the transferring requirement. The queuing circuits store the under-transferring packets to one of the queuing circuits according to the transferring requirement. The merging circuit performs a merging process to merge the under-transferring packets stored in one of the queuing circuits that meets merging criteria to be a merged packet. The packet transceiver circuit processes the merged packet to generate a second network packet to be transmitted to the second network.

### BACKGROUND OF THE INVENTION

### 1. Field of the Invention

The present invention relates to a network apparatus having a merged packet processing mechanism.

### 2. Description of Related Art

WiFi technology is a wireless local area network technology based on IEEE 802.11 standard and has become a mainstream technology along with the development of wireless network technology. Wireless transmission efficiency is critical due to the popularity of WiFi technology. However, when the data amount of the transmission packets is less than a threshold value, additional information included in the packets occupies a fairly large percentage of the total transmission amount such that the transmission efficiency is decreased.

### SUMMARY OF THE INVENTION

In consideration of the problem of the prior art, an object of the present invention is to supply a network apparatus having a merged packet processing mechanism.

The present invention discloses a network apparatus having a merged packet processing mechanism that includes a packet transceiver circuit and a packet transferring circuit. The packet transceiver circuit is configured to receive a plurality of first network packets from a first network. The packet transferring circuit is disposed independently from the packet transceiver circuit and includes a determining circuit, a processing circuit, a plurality of queuing circuits and a merging circuit. The determining circuit is configured to determine and select a plurality of under-transferring packets each having a transferring requirement corresponding to a second network from the first network packets. The processing circuit is configured to perform a packet processing on each of the under-transferring packets according to the transferring requirement. The queuing circuits are configured to store each of the under-transferring packets having the packet processing performed thereon to one of the queuing circuits according to the transferring requirement. The merging circuit is configured to perform a merging process to merge the under-transferring packets stored in one of the queuing circuits that meets merging criteria to be a merged packet and further allow the packet transceiver circuit to process the merged packet to generate and transmit a second network packet to the second network.

The present invention also discloses a network apparatus having a merged packet processing mechanism that includes a packet transceiver circuit and a packet transferring circuit. The packet transceiver circuit is configured to receive a first network packet from a first network and determine that the first network packet is a merged packet. The packet transferring circuit is disposed independently from the packet transceiver circuit and includes a determining circuit and a processing circuit. The determining circuit is configured to determine and select a plurality of under-transferring packets each having a transferring requirement corresponding to a second network from a plurality decomposed packets decomposed from the merged packet. The processing circuit is configured to perform a packet processing on the under-transferring packets according to the transferring requirement to generate a plurality of second network packets and further transmit the second network packet to a second network through the packet transceiver circuit.

These and other objectives of the present invention will no doubt become obvious to those of ordinary skill in the art behind reading the following detailed description of the preferred embodiments that are illustrated in the various figures and drawings.

### BRIEF DESCRIPTION OF THE DRAWINGS

FIG. 1 illustrates a block diagram of a network apparatus having a merged packet processing mechanism according to an embodiment of the present invention.

FIG. 2 illustrates a block diagram of a network apparatus having a merged packet processing mechanism according to an embodiment of the present invention.

FIG. 3 illustrates a block diagram of a network apparatus having a merged packet processing mechanism according to an embodiment of the present invention.

FIG. 4 illustrates a block diagram of a network apparatus having a merged packet processing mechanism according to an embodiment of the present invention.

### DETAILED DESCRIPTION OF THE PREFERRED EMBODIMENTS

An aspect of the present invention is to provide a network apparatus having a merged packet processing mechanism to perform a merged packet processing by using a hardware circuit to not only avoid the condition that the transmission bandwidth is occupied by additional information in the individual packet transmission occurs, but also increase the transmission efficiency without occupying the software resource of the processor.

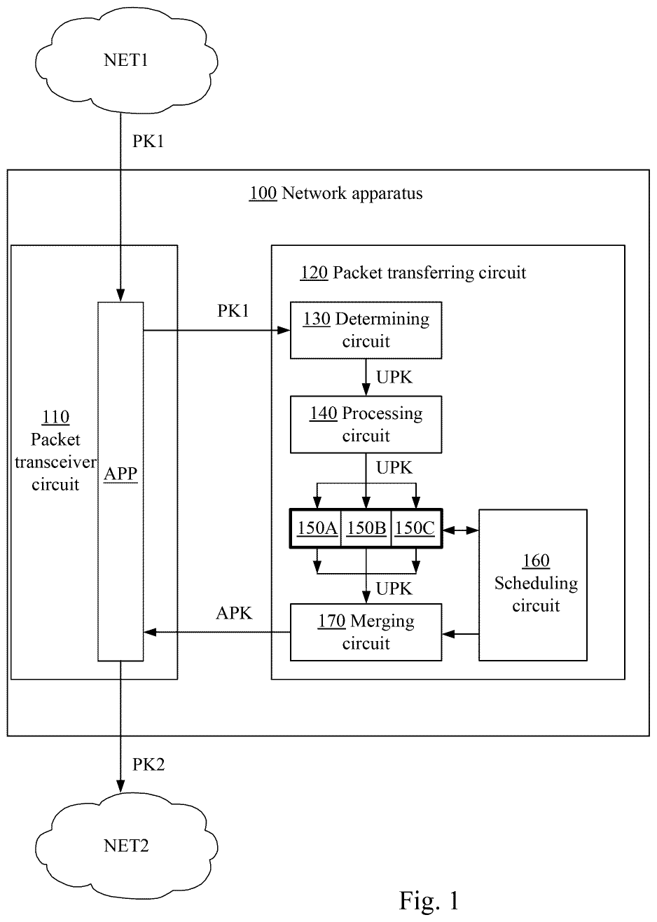

Reference is now made to FIG. 1. FIG. 1 illustrates a block diagram of a network apparatus 100 having a merged packet processing mechanism according to an embodiment of the present invention. In an embodiment, the network apparatus 100 is such as, but not limited to a router apparatus in a network system. The network apparatus 100 includes a packet transceiver circuit 110 and a packet transferring circuit 120.

The packet transceiver circuit 110 is configured to receive a plurality of first network packets PK1 from a first network NET1. In an embodiment, the first network NET1 is an Ethernet network. The packet transceiver circuit 110 is configured to operate an application program APP to receive the first network packets PK1. In an embodiment, the application program APP is a driver program of the network apparatus 100.

The packet transferring circuit 120 is disposed independently from the packet transceiver circuit 110. In an embodiment, the packet transferring circuit 120 is implemented by an application specific integrated circuit (ASIC) such that the packet transferring circuit 120 performs packet transferring independently without the processing of the application program APP in the packet transceiver circuit 110.

In the present embodiment, the packet transferring circuit 120 includes determining circuit 130, a processing circuit 140, a plurality of the queuing circuits 150A~150C, a scheduling circuit 160 and a merging circuit 170.

The determining circuit 130 is configured to determine and select a plurality of under-transferring packets UPK each having a transferring requirement corresponding to a second network NET2 from the first network packets PK1.

In an embodiment, the second network NET2 is a WiFi network. The transferring requirement associated with a target address of each of the under-transferring packets UPK and the target address corresponds to the second network NET2.

More specifically, the determining circuit 130 determines the target address of each of the first network packets PK1 according to such as, but not limited to information of data link layer (Layer2), network layer (Layer3), a transmission layer (Layer4) or a combination thereof of each of the first network packets PK1, wherein the target address is a network address and/or a media access control (MAC) address of a target apparatus that the first network packets PK1 are supposed to be transferred to. When the target address can only be transferred through the second network NET2, the determining circuit 130 selects the first network packets PK1 to be the under-transferring packets UPK.

The processing circuit 140 is configured to perform a packet processing on each of the under-transferring packets UPK according to transferring requirement. In an embodiment, the packet processing performed by the processing circuit 140 according to the transferring requirement includes a target address retrieving, a packet content amending, a packet format converting or a combination thereof.

In an embodiment, the target address is retrieved from the information the data link layer, the network layer, the transmission layer or a combination thereof of the under-transferring packets UPK described above. Since the first network is the Ethernet network and the second network is the WiFi network, the processing circuit 140 converts each of the under-transferring packets UPK from an Ethernet network format to a sub-network access protocol (SNAP) format. After conversion, each of the under-transferring packets UPK becomes a MAC service data unit (MSDU) that can be transmitted in the WiFi network. Moreover, the processing circuit 140 may amend the content of the under-transferring packets UPK according to the requirements corresponding to the routing or network address translation (NAT) in the transferring requirement.

The queuing circuits 150A~150C are configured to store each of the under-transferring packets UPK having the packet processing performed thereon to one of the queuing circuits 150A~150C according to the transferring requirement.

In an embodiment, the processing circuit 140 configures the queuing circuits 150A~150C such that each of the queuing circuits 150A~150C corresponds to a transferring address. Under the control of the processing circuit 140, each of the queuing circuits 150A~150C stores the under-transferring packets UPK having the target address matching the transferring address.

More specifically, when the processing circuit 140 determines that the target address of one of the under-transferring packets UPK matches the transferring address of the queuing circuit 150A, the processing circuit 140 controls the queuing circuit 150A to store such an under-transferring packet UPK. When the under-transferring packets UPK determines that the target address of one of the under-transferring packets UPK meets the transferring address of one of the queuing circuits 150B~150C, the processing circuit 140 may also control one of the queuing circuits 150B~150C to store such an under-transferring packet UPK. The detail is not described herein.

It is appreciated that the number of the queuing circuits 150A~150C illustrated in FIG. 1 is merely an example. In other embodiments, the number of the queuing circuits may be different depending on the practical requirements. The present invention is not limited thereto.

The scheduling circuit 160 is configured to perform a scheduling process, and the scheduling process is configured to monitor a packet storage amount or a packet storage time of each of the queuing circuits 150A~150C so as to determine that merging criteria is met when the packet storage amount of any one of the queuing circuits 150A~150C reaches a storage amount upper limit or the packet storage time of any one of the queuing circuits 150A~150C reaches a time upper limit, and control the merging circuit 170 to initiate a merging process. It is appreciated that the term “packet storage amount” is referred to a data length, a packet number of a combination thereof of the packets stored in each of the queuing circuits.

The merging circuit 170 is configured to perform the merging process according to the scheduling process to merge the under-transferring packets UPK stored in one of the queuing circuits 150A~150C that meets the merging criteria to be a merged packet APK and further allow the packet transceiver circuit 110 to process the merged packet APK to generate and transmit a second network packet PK2 to the second network NET2.

In an embodiment, the packet transceiver circuit 110 may operate the application program APP to attach a header corresponding to the second network NET2, e.g., a header in the format of 802.11, to the merged packet APK to generate and transmit the second network packet PK2 to the second network NET2.

It is appreciated that the packet merging mechanism can be applied to the packets to be transmitted to the second network NET2. However, the network apparatus 100 may receive packets of other types. For example, when a part of the packets received by the network apparatus 100 is to be transferred through the Ethernet network, the packet transceiver circuit 110 may such as, but not limited to directly transfer the packets directly according to the target address without performing merging. When the network apparatus 100 is such as but not limited to a terminal apparatus in a network, e.g., a computer host, that receives the packets having the target address corresponding to itself, the packet transceiver circuit 110 may receive and transmit the packets to higher network levels. The present invention is not limited thereto.

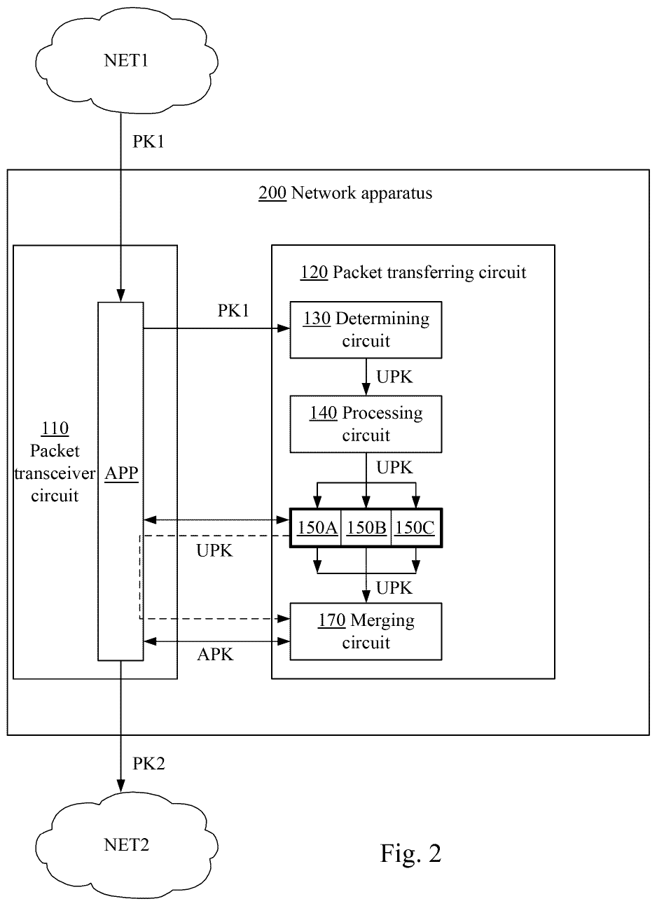

Reference is now made to FIG. 2. FIG. 2 illustrates a block diagram of a network apparatus 200 having a merged packet processing mechanism according to an embodiment of the present invention. The network apparatus 200 includes the packet transceiver circuit 110 and the packet transferring circuit 120. However, compared with the network apparatus 100 in FIG. 1, the packet transferring circuit 120 in the network apparatus 200 only includes the determining circuit 130, the processing circuit 140, the queuing circuits 150A~150C and the merging circuit 170. The configuration and the operation of these circuits are identical to the corresponding circuits in FIG. 1. The details are not described herein.

In the present embodiment, the scheduling process performed by the scheduling circuit 160 in FIG. 1 is performed by the application program APP operated in the packet transceiver circuit 110. In an embodiment, the application program APP may directly monitor the packet storage amount or the packet storage time of each of the queuing circuits 150A~150C such that when the merging criteria is determined to be met, the application program APP allows the merging circuit 170 to read the under-transferring packets UPK from the queuing circuits to perform the merging process.

In other embodiments, the application program APP may read the under-transferring packets UPK from the queuing circuits 150A~150C along the dashed line from the queuing circuits 150A~150C, the application program APP to the merging circuit 170 illustrated in FIG. 2 and store the under-transferring packets UPK in the queue of the application program APP so as to monitor the packet storage amount or the packet storage time of the under-transferring packets UPK corresponding to each of the queuing circuits such that when the merging criteria is determined to be met, the application program APP reads and transmits the under-transferring packets UPK from the queues to the merging circuit 170 to perform the merging process.

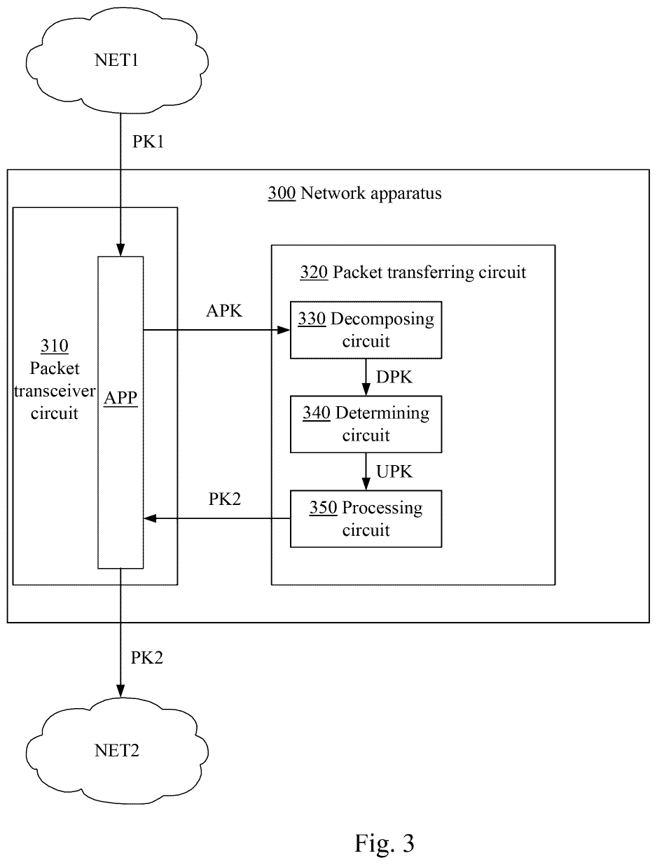

Reference is now made to FIG. 3. FIG. 3 illustrates a block diagram of a network apparatus 300 having a merged packet processing mechanism according to an embodiment of the present invention. In an embodiment, the network apparatus 300 is such as, but not limited to a router apparatus in a network system. The network apparatus 300 includes a packet transceiver circuit 310 and a packet transferring circuit 320.

The packet transceiver circuit 310 is configured to receive a first network packet PK1 from a first network NET1 and determine that the first network packet PK1 is the merged packet APK. In an embodiment, the first network NET1 is the WiFi network. The first network packet PK1 has the WiFi network format. The packet transceiver circuit 310 is configured to operate the application program APP to receive the first network packet PK1, remove the header of the first network packet PK1 and determine that the first network packet PK1 to be the merged packet APK according to the configuration thereof. In an embodiment, the application program APP is the driver program of the network apparatus 300.

The packet transferring circuit 320 is disposed independent from the packet transceiver circuit 310. In an embodiment, the packet transferring circuit 320 is implemented by an application specific integrated circuit such that the packet transferring circuit 320 performs packet transferring independently without the processing of the application program APP in the packet transceiver circuit 310.

In the present embodiment, the packet transferring circuit 320 includes a decomposing circuit 330, a determining circuit 340 and a processing circuit 350.

The merged packet APK can be decomposed into a plurality of decomposed packets DPK by using a decomposing process. In the present embodiment, the decomposing process is performed by the decomposing circuit 330 and is configured to determine that the merged packet APK corresponds to a transmission format of the first network NET1 so as to perform a byte aligning to decompose the merged packet APK into the decomposed packets DPK.

For example, the decomposing circuit 330 may determine that the merged packet APK has a transmission format of such as, but not limited to WiFi6 or Wifi7, performing decomposing to generate a decomposed packet from a front-most section equaling the size of a length entry of a MAC service data unit of the merged packet APK, perform a byte aligning of such as but not limited to 4 bytes to decompose and generate the next decomposed packet and keep performing the decomposing process associated with the length entry and the 4-byte aligning described above until the end of the merged packet APK.

The determining circuit 340 is configured to determine and select a plurality of under-transferring packets UPK each having a transferring requirement corresponding to a second network NET2 from the decomposed packets DPK decomposed from the merged packet APK. In an embodiment, the second network NET2 is the Ethernet network. The transferring requirement is associated with a target address of each of the under-transferring packets UPK and the target address corresponds to the second network NET2.

More specifically, the determining circuit 340 determines the target address of each of the decomposed packets DPK according to such as, but not limited to information of data link layer (Layer2), network layer (Layer3), a transmission layer (Layer4) or a combination thereof of each of the decomposed packets DPK, wherein the target address is a network address and/or a media access control address of a target apparatus that the decomposed packets DPK are supposed to be transferred to. When the target address can only be transferred through the second network NET2, the determining circuit selects the decomposed packets DPK to be the under-transferring packets UPK.

The processing circuit 350 is configured to perform a packet processing on each of the under-transferring packets UPK according to transferring requirement to generate a plurality of second network packets PK2. In an embodiment, the packet processing performed by the processing circuit 350 according to the transferring requirement includes a target address retrieving, a packet content amending, a packet format converting or a combination thereof.

In an embodiment, the target address is retrieved from the information the data link layer, the network layer, the transmission layer or a combination thereof of the under-transferring packets UPK described above. Since the first network is the WiFi network and the second network is Ethernet network, the processing circuit 350 converts each of the under-transferring packets UPK from a sub-network access protocol format to an Ethernet network format. After conversion, each of the under-transferring packets UP has the format that can be transmitted in the Ethernet network. Moreover, the processing circuit 350 may amend the content of the under-transferring packets UPK according to the requirements corresponding to the routing or network address translation in the transferring requirement.

The processing circuit 350 further transmits the second network packets PK2 through the packet transceiver circuit 310 to the second network NET2.

It is appreciated that the decomposition and transferring mechanism of the merged packet can be applied to the merged packet having the configuration described above. However, the network apparatus 300 may receive packets of other types. For example, when a part of the first network packets received by the network apparatus 300 are not the merged packets, these packets can be transferred without being decomposed. When the network apparatus 300 is such as but not limited to a terminal apparatus in a network, e.g., a computer host, that receives the merged packet having the target address corresponding to itself, the packet transceiver circuit 310 may receive and transmit the packets to higher network levels. The present invention is not limited thereto.

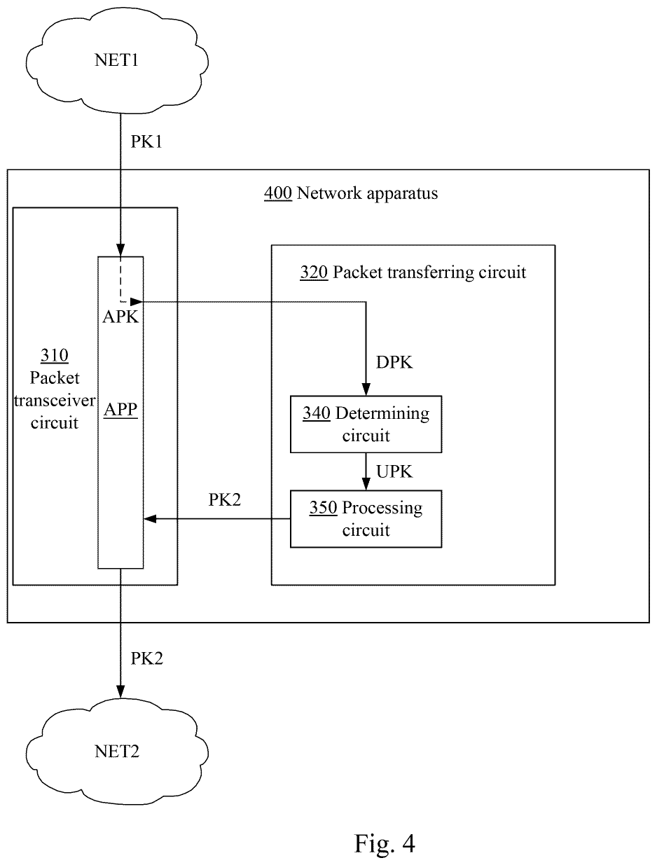

Reference is now made to FIG. 4. FIG. 4 illustrates a block diagram of a network apparatus 400 having a merged packet processing mechanism according to an embodiment of the present invention. The network apparatus 400 includes the packet transceiver circuit 310 and the packet transferring circuit 320. However, compared with the network apparatus 300 in FIG. 3, the packet transferring circuit 320 in the network apparatus 400 only includes the determining circuit 340 and the processing circuit 350. The configuration and the operation of these circuits are identical to the corresponding circuits in FIG. 3. The details are not described herein.

In the present embodiment, the decomposing process performed by the decomposing circuit 330 in FIG. 3 is performed by the application program APP operated in the packet transceiver circuit 310 to decompose the merged packet APK into the decomposed packets DPK. In the present embodiment, the receiving and the decomposition of the merged packet APK are both performed by the application program APP operated in the packet transceiver circuit 310 such that the determining circuit 340 and the processing circuit 350 subsequently performs processing and transferring on the packets UPK.

In the embodiments described above, the merged packet processing mechanism performed by the network apparatus 100 and the network apparatus 200 is to generate the merged packet, and the merged packet processing mechanism performed by the network apparatus 300 and the network apparatus 400 is to decompose the merged packet. However, in some embodiments, a single network apparatus may be equipped with both of the merged packet processing mechanism for generating the merged packet and the merged packet processing mechanism for decomposing the merged packet. For example, in some embodiments, a network apparatus may receive and merge a plurality of packets from the Ethernet network to be transmitted to the WiFi network and may also receive and decompose the merged packet from the WiFi network to be transmitted to the Ethernet network. The present invention is not limited thereto.

It is appreciated that the embodiments described above are merely an example. In other embodiments, it should be appreciated that many modifications and changes may be made by those of ordinary skill in the art without departing, from the spirit of the disclosure.

In summary, the present invention discloses the network apparatus having a merged packet processing mechanism that performs a merged packet processing by using a hardware circuit to not only avoid the condition that the transmission bandwidth is occupied by additional information in the individual packet transmission occurs, but also increase the transmission efficiency without occupying the software resource of the processor.

The aforementioned descriptions represent merely the preferred embodiment of the present invention, without any intention to limit the scope of the present invention thereto. Various equivalent changes, alterations, or modifications based on the claims of present invention are all consequently viewed as being embraced by the scope of the present invention.

What is claimed is:

1. A network apparatus having a merged packet processing mechanism, comprising:
a packet transceiver circuit configured to receive a plurality of first network packets from a first network; and
a packet transferring circuit disposed independently from the packet transceiver circuit and comprising:
a determining circuit configured to determine and select a plurality of under-transferring packets each having a transferring requirement corresponding to a second network from the first network packets;
a processing circuit configured to perform a packet processing on each of the under-transferring packets according to the transferring requirement;
a plurality of queuing circuits configured to store each of the under-transferring packets having the packet processing performed thereon to one of the queuing circuits according to the transferring requirement; and
a merging circuit configured to perform a merging process to merge the under-transferring packets stored in one of the queuing circuits that meets a merging criteria to be a merged packet and further allow the packet transceiver circuit to process the merged packet to generate and transmit a second network packet to the second network.

2. The network apparatus of claim 1, wherein the transferring requirement is associated with a target address of each of the under-transferring packets and the target address corresponds to the second network;
the packet processing performed by the processing circuit according to the transferring requirement comprises a target address retrieving, a packet content amending, a packet format converting or a combination thereof such that each of the queuing circuits corresponds to a transferring address to store the under-transferring packets having the target address matching the transferring address, and the packet transceiver circuit is configured to attach a header corresponding to the second network to the merged packet to generate and transmit the second network packet to the second network.

3. The network apparatus of claim 2, wherein the first network is an Ethernet network and the second network is a WiFi network, and the packet format converting performed by the processing circuit according to the transferring requirement is to convert each of the under-transferring packets from an Ethernet network format to a sub-network access protocol (SNAP) format.

4. The network apparatus of claim 1, wherein the merging circuit is configured to perform the merging process according to a scheduling process, and the scheduling process is performed by a scheduling circuit further comprised by the packet transferring circuit or an application program executed by the packet transceiver circuit, and is configured to monitor a packet storage amount or a packet storage time of each of the queuing circuits so as to determine that the merging criteria is met when the packet storage amount of any one of the queuing circuits reaches a storage amount upper limit or the packet storage time any one of the queuing circuits reaches a time upper limit and control the merging circuit to initiate the merging process;
wherein the packet storage amount is a data length, a packet number of a combination thereof.

5. The network apparatus of claim 1, wherein the packet transferring circuit is implemented by an application specific integrated circuit (ASIC).

6. A network apparatus having a merged packet processing mechanism, comprising:
a packet transceiver circuit configured to receive a first network packet from a first network and determine that the first network packet is a merged packet; and
a packet transferring circuit disposed independently from the packet transceiver circuit and comprising:
a determining circuit configured to determine and select a plurality of under-transferring packets each having a transferring requirement corresponding to a second network from a plurality decomposed packets decomposed from the merged packet; and
a processing circuit configured to perform a packet processing on the under-transferring packets according to the transferring requirement to generate a plurality of second network packets and further transmit the second network packets to a second network through the packet transceiver circuit.

7. The network apparatus of claim 6, wherein the transferring requirement is associated with a target address of each of the under-transferring packets and the target address corresponds to the second network;
the packet transceiver circuit is configured to remove a header corresponding to the first network of the first network packet and determine that the first network packet is the merged packet according to a configuration thereof, and the packet processing performed by the processing circuit according to the transferring requirement includes a target address retrieving, a packet content amending, a packet format converting or a combination thereof.

8. The network apparatus of claim 7, wherein the first network WiFi network and the second network are Ethernet networks, and the packet format converting performed by the processing circuit according to the transferring requirement is to convert each of the under-transferring packets from a sub-network access protocol format to an Ethernet network format.

9. The network apparatus of claim 6, wherein the merged packet is decomposed to the decomposed packets according to a decomposing process and the decomposing process is performed by a decomposing circuit further comprised by the packet transferring circuit or an application program executed by the packet transceiver circuit, and is configured to determine that the merged packet corresponds to a transmission format of the first network so as to perform a byte aligning to decompose the merged packet into the decomposed packets.

10. The network apparatus of claim 6, wherein the packet transferring circuit is implemented by an application specific integrated circuit.
